(19) United States
(12) Patent Application Publication
(10) Pub. No.: US 2026/0074322 A1
(43) Pub. Date: Mar. 12, 2026

(54) CERAMIC HEATER MODULE CONTROL APPARATUS, AND CERAMIC HEATER UNIT

(71) Applicant: Niterra Co., Ltd., Nagoya-shi (JP)

(72) Inventors: Hiroaki NAKANISHI, Nagoya-shi (JP); Seiji MAEDA, Nagoya-shi (JP); Keiichi OZAWA, Nagoya-shi (JP); Shosuke IIDA, Nagoya-shi (JP)

(73) Assignee: Niterra Co., Ltd., Nagoya-shi (JP)

(21) Appl. No.: 19/308,497

(22) Filed: Aug. 25, 2025

(30) Foreign Application Priority Data
Sep. 10, 2024 (JP) 2024-156756

(51) Int. Cl. H01M 10/6571; H01M 10/615; H01M 10/625; H01M 10/633; H01M 10/6568; H05B 1/02; H05B 3/14

(52) U.S. Cl. CPC H01M 10/6571; H01M 10/615; H01M 10/625; H01M 10/633; H01M 10/6568; H05B 1/0236; H05B 1/0244; H05B 3/141; H05B 2203/021

(57) ABSTRACT

A control apparatus controls a ceramic heater module which includes a ceramic heater including a resistive heating element, and a case housing the ceramic heater and having an inlet and an outlet through which a liquid medium flows. The control apparatus obtains, as an outlet temperature, a temperature on an outlet side of the ceramic heater module, and determines whether or not a stop condition is satisfied, on the basis of a temperature difference between a start temperature (the outlet temperature at an energization start time point at which energization of the resistive heating element is started) and a detection temperature (the outlet temperature obtained at one or a plurality of specific time points after the energization start time point). The control apparatus stops the energization of the resistive heating element when it determines that the stop condition is satisfied.

### BACKGROUND OF THE INVENTION

### Technical Field

The present disclosure relates to a ceramic heater module control apparatus, and to a ceramic heater unit.

### Description of the Related Art

Conventionally, a PTC heater, a sheath heater, etc. have been known as heaters for heating and controlling a heat medium. For example, in Patent document 1, a PTC heater is shown as an example of a heating device for heating a battery mounted in a battery-driven vehicle.

### PRIOR ART DOCUMENTS

### Patent Documents

Patent document 1: JP2023-136087A

These heaters are slow in temperature elevation and have the drawbacks of being large and heavy. In view of this, use of a ceramic heater module has been considered. The ceramic heater module includes a ceramic heater and a case. The ceramic heater has a ceramic base body with a resistive heating element embedded therein, and the resistive heating element generates heat so as to heat a liquid flowing along the surface of the ceramic heater. The case contains the ceramic heater and has an inlet and an outlet through which the liquid flows. In the case where the liquid is heated by the ceramic heater, the ceramic heater is heated as a result of heat generation of the resistive heating element and is cooled by the liquid. Therefore, the surface temperature of the ceramic heater gradually approaches a predetermined temperature at which the heating by the resistive heating element balances with the cooling by the liquid. The liquid flowing along the surface of the ceramic heater whose temperature is gradually approaching the predetermined temperature is heated by the heat of the ceramic heater. Since such a ceramic heater has an excellent temperature elevating performance and is small and light, the ceramic heater is expected to serve as a heater that can overcome the above-described drawbacks.

However, cracking or melting damage of the ceramic heater may occur in an abnormal state. This will be specifically described below.

In general, a ceramic heater module is configured such that the liquid flows along the surface of the ceramic heater (in other words, through a flow passage in the ceramic heater module) at a predetermined flow rate. However, if the output of a pump decreases or foreign matter is mixed into the liquid, there may occur an abnormal state in which, when the ceramic heater is activated (in other words, when supply of power to the resistive heating element (hereinafter referred to also as “energization of the resistive heating element”) is started), the flow rate of the liquid flowing along the heater surface decreases or the liquid stagnates. In these cases, the liquid may boil as a result of excessive heating of the liquid by the ceramic heater. When the liquid boils, boiling bubbles (bubbles produced as a result of boiling) come into contact with the heater surface, whereby a region where the liquid does not come into contact with the heater surface is formed on the heater surface. Since the region where the liquid does not come into contact with the heater surface is not cooled by the liquid, the temperature of that region increases sharply. When the liquid comes into contact with the region as a result of, for example, moving of the boiling bubbles, since that region is cooled rapidly by the liquid, thermal shock acts on the ceramic heater. Since the ceramic base body constituting the ceramic heater is vulnerable to thermal shock, if the thermal shock is large, cracking may occur in the ceramic heater.

Alternatively, a decrease in pump output, mixing of foreign matter into the liquid, and other situations may cause occurrence of an abnormal state in which no liquid is present on the heater surface. In this state, when activation of the ceramic heater is started, since the ceramic heater is heated by the heat generation of the resistive heating element without being cooled by the liquid, the surface temperature increases sharply, resulting in so-called no-water heating, and melting damage of the ceramic heater may occur.

### SUMMARY OF THE INVENTION

The present invention has been made to solve the above-described problem. Namely, one object of the present invention is to provide a technique which can reliably prevent cracking or melting damage of the ceramic heater even when an abnormal state occurs.

### Means for Solving the Problems

A ceramic heater module control apparatus (35) according to the present invention controls a ceramic heater module (1) which includes a ceramic heater (20) having a ceramic base body including a resistive heating element embedded therein, and a case (10) housing the ceramic heater and having an inlet (11) and an outlet (12) through which a liquid medium flows.

The ceramic heater module control apparatus is configured to:
obtain, as an outlet temperature, a temperature on an outlet side with respect to the ceramic heater module;
determine whether or not a predetermined stop condition is satisfied (S16, S21, S23), on the basis of a temperature difference (ΔT1, ΔT2) between a start temperature (Ts) and a detection temperature (T1, T2), the start temperature (Ts) being the outlet temperature at an energization start time point (t=0) at which energization of the resistive heating element with a predetermined power Pl) is started, and the detection temperature (T1, T2) being the outlet temperature obtained at one or a plurality of specific time points after the energization start time point; and
stop the energization of the resistive heating element (S17, S22) in the case where it is determined that the stop condition is satisfied (S16: Yes, S21: Yes, S23: Yes).

### Effects of the Invention

The temperature difference between the start temperature (the outlet temperature at the energization start time point) and the detection temperature (the outlet temperature obtained at one or a plurality of specific time points after the energization start time point) has a correlation with the flow rate of the liquid medium flowing along the surface of the ceramic heater. For example, in the case where the temperature difference is excessively small (in other words, in the case where elevation of the detection temperature is smaller than that during normal time), there is a high possibility that the liquid medium flowing along the heater surface stagnates (namely, the flow rate is zero) or the liquid medium is not present on the heater surface. Meanwhile, in the case where the temperature difference is excessively large (in other words, in the case where elevation of the detection temperature is larger than that during normal time), there is a high possibility that the flow rate of the liquid medium flowing along the heater surface is small (insufficient). The ceramic heater module control apparatus according to the present invention determines, on the basis of the temperature difference, whether or not the stop condition is satisfied, and stops the energization of the resistive heating element in the case where the ceramic heater module control apparatus determines that the stop condition is satisfied. Therefore, the stop condition can be set in accordance with the flow rate of the liquid medium estimated on the basis of the temperature difference between the start temperature and the detection temperature. Accordingly, it becomes possible to properly determine whether or not an abnormal state has occurred on the basis of the result of the determination as to whether the stop condition is satisfied, and the energization of the resistive heating element can be stopped without fail in the case where an abnormal state has occurred. By virtue of this configuration, cracking or melting damage of the ceramic heater can be prevented without fail even when an abnormal state occurs.

In one aspect of the present invention, the predetermined power is power (Pl) smaller than normal power (Pn) suppled to the resistive heating element during normal operation of the ceramic heater (20).

By virtue of this configuration, the amount of heat generated by the resistive heating element per unit time can be reduced as compared with a configuration in which the normal power is supplied to the resistive heating element as the predetermined power, whereby elevation of the surface temperature of the ceramic heater can be suppressed. Accordingly, even when an abnormal state occurs, boiling of the liquid medium flowing along the heater surface, a no-water heating state of the heater, or a like situation is less likely to occur. As a result, it is possible to prevent cracking or melting damage of the ceramic heater, which would otherwise occur in the middle of the determination as to whether or not the stop condition is satisfied.

In one aspect of the present invention,
the stop condition includes a first stop condition,
the specific time point is a first reference time point after elapse of a predetermined first time period (t1) from the energization start time point (t=0), and
the control apparatus (35) determines that the first stop condition is satisfied in the case where the temperature difference (ΔT1) is equal to or smaller than a predetermined first threshold value (T1ₜₕ) (S16: Yes).

When energization of the resistive heating element is started in a state in which the liquid medium flowing along the surface of the ceramic heater stagnates, the temperature of the liquid medium near the ceramic base body increases, and natural convection of the liquid medium occurs, whereby heat is transferred. Therefore, the outlet temperature (the temperature on the outlet side of the ceramic heater module) tends to increase more slowly as compared with the outlet temperature during normal time (in which the liquid medium flows along the heater surface at a predetermined flow rate). In addition, when energization of the resistive heating element is started in a state in which the liquid medium is not present on the heater surface, the temperature of the air near the ceramic base body increases, and natural convection of the air occurs, whereby heat is transferred. Therefore, the outlet temperature tends to increase more slowly as compared with the outlet temperature during normal time. Namely, in the case where the liquid medium stagnates or is not present, the temperature difference between the start temperature and the detection temperature tends to become smaller than the temperature difference during normal time. The ceramic heater module control apparatus according to one aspect of the present invention determines that the first stop condition is satisfied in the case where the temperature difference between the start temperature and the detection temperature at the first reference time point (the point in time after elapse of the first time period from the energization start time point) is equal to or smaller than the first threshold value. By virtue of this configuration, it is possible to properly determine whether or not one type of an abnormal state in which elevation of the outlet temperature is relatively gentle (namely, the liquid medium stagnates or is absent) has occurred.

Notably, in the present specification, the “temperature difference between the start temperature and the detection temperature” is defined as the absolute value of the difference between the start temperature and the detection temperature.

One aspect of the present invention, the predetermined power is power (Pl) smaller than normal power (Pn) supplied to the resistive heating element during normal operation of the ceramic heater (20), and
in the case where the control apparatus (35) determines that the first stop condition is not satisfied (S16: No), the control apparatus (35) maintains the power supplied to the resistive heating element at the predetermined power (Pl) until a predetermined reference time point after the first reference time point.

There are two types of abnormal states; i.e., an abnormal state in which the outlet temperature increases relatively slowly and an abnormal state in which the outlet temperature increases relatively sharply. The “configuration which determines whether or not the first stop condition is satisfied” can determine whether or not the abnormal state of the former type has occurred; however, cannot determine whether or not the abnormal state of the latter type has occurred. In addition, the abnormal state of the latter type may occur at any timing, depending on, for example, the power supplied to the resistive heating element (namely, the abnormal state of the latter type may occur before the first reference time point in some cases or occur after the first reference time point in some cases). The ceramic heater module control apparatus according to one aspect of the present invention is configured such that, in the case where the ceramic heater module control apparatus determines that the first stop condition is not satisfied, the ceramic heater module control apparatus continuously supplies the power smaller than the normal power to the resistive heating element until a predetermined reference time point (a point in time after the first reference time point). By virtue of this configuration, in the case where the first stop condition is not satisfied, the supply of the small power is continued until the predetermined reference time point. Therefore, even in the case where the abnormal state of the latter type occurs after the first reference time point, elevation of the surface temperature of the ceramic heater can be suppressed, and consequently, cracking of the ceramic heater can be prevented.

The control apparatus may be configured to perform the determination as to whether or not the abnormal state of the latter type has occurred, in addition to the determination as to whether or not the first stop condition is satisfied. In this configuration, in the case where the control apparatus determines that the abnormal state of the latter type has occurred before the first reference time point, the control apparatus may stop the energization of the resistive heating element at the point in time when that determination is performed. In this case, the determination as to whether or not the first stop condition is satisfied is not performed.

In one aspect of the present invention,
the stop condition includes a second stop condition,
the specific time point is each of a plurality of points in time which successively come, every time a predetermined short time elapses, after the energization start time point,
the control apparatus (35) determines that the second stop condition is satisfied in the case where the temperature difference (ΔT2) is equal to or larger than a predetermined second threshold value (T2ₜₕ) (S21: Yes, S23: Yes), and
in the case where the second stop condition is not satisfied, the control apparatus (35) continues the determination as to whether or not the second stop condition is satisfied, until a second reference time point after elapse of a predetermined second time period (t2) from the energization start time point.

When energization of the resistive heating element is started in a state in which the flow rate of the liquid medium flowing along the surface of the heater is small, the outlet temperature tends to increase sharply as compared with the outlet temperature during normal time, because, when the flow rate of the liquid medium is small (namely, the flow speed is low), the time over which the liquid medium is in contact with the heater surface becomes longer, and the temperature of the liquid medium increases more quickly as compared with the temperature increase during normal time. Namely, in the case where the flow rate of the liquid medium is small, the temperature difference between the start temperature and the detection temperature tends to become larger than the temperature difference during normal time. The ceramic heater module control apparatus according to one aspect of the present invention determines that the second stop condition is satisfied in the case where the temperature difference between the start temperature and the detection temperature at the specific time point (each of the plurality of points in time which successively come, every time the predetermined short time elapses, after the energization start time point) is equal to or larger than the second threshold value. This determination is continued until the second reference time point (a point in time after elapse of the second time period from the energization start time point). By virtue of this configuration, it is possible to properly determine whether or not an abnormal state of a type in which elevation of the outlet temperature is relatively sharp (namely, the flow rate of the liquid medium is insufficient) has occurred.

One aspect of the present invention, the predetermined power is power (Pl) smaller than normal power (Pn) supplied to the resistive heating element during normal operation of the ceramic heater (20),
in the case where the control apparatus (35) determines that the second stop condition is not satisfied before the second reference time point (S21: No), the control apparatus (35) maintains the power supplied to the resistive heating element at the predetermined power (Pl), and
in the case where the control apparatus (35) determines that the second stop condition is not satisfied at the second reference time point (S23: No), the control apparatus (35) changes the power supplied to the resistive heating element from the predetermined power (Pl) to the normal power (Pn) (S20).

If the power supplied to the resistive heating element is immediately changed to the normal power (namely, the supplied power is increased) when unsatisfaction of the second stop condition is determined at a certain time point before the second reference time point, there arises a possibility that, when an abnormal state subsequently occurs after the certain time point, the surface temperature of the ceramic heater increases greatly, and cracking of the ceramic heater occurs. In contrast, by virtue of the above-described configuration, supply of small power is continued in the case where unsatisfaction of the second stop condition is determined before the second reference time point (namely, in the case where insufficiency of the flow rate of the liquid medium does not occur). Therefore, elevation of the surface temperature of the ceramic heater can be suppressed, and consequently, cracking of the ceramic heater can be prevented. In addition, in the case where the second stop condition is not satisfied at the second reference time point, the power supplied to the resistive heating element is changed from the small power to the normal power. Therefore, the liquid medium can be appropriately heated by the ceramic heater.

Another ceramic heater module control apparatus (35) according to the present invention controls a ceramic heater module (1) which includes a ceramic heater (20) having a ceramic base body including a resistive heating element embedded therein, and a case (10) housing the ceramic heater and having an inlet (11) and an outlet (12) through which a liquid medium flows.

The ceramic heater module control apparatus is configured to:
obtain, as an inlet temperature (T3in, T4in), a temperature on an inlet side with respect to the ceramic heater module, and obtain, as an outlet temperature (T3, T4), a temperature on an outlet side with respect to the ceramic heater module;
determine whether or not a predetermined stop condition is satisfied, on the basis of a temperature difference (ΔT3, ΔT4) between the inlet temperature and the outlet temperature at one or a plurality of specific time points after an energization start time point (t=0) at which energization of the resistive heating element with a predetermined power is started; and
stop the energization of the resistive heating element in the case where it is determined that the stop condition is satisfied.

In this configuration, the inlet temperature and the outlet temperature are obtained at the specific time point (one or a plurality of points in time after the energization start time point). The inlet temperature and the outlet temperature are obtained at the same timing. The temperature difference between the inlet temperature and the outlet temperature has a correlation with the flow rate of the liquid medium flowing along the surface of the ceramic heater. The ceramic heater module control apparatus according to the present invention determines, on the basis of the temperature difference, whether or not the stop condition is satisfied, and stops the energization of the resistive heating element in the case where the ceramic heater module control apparatus determines that the stop condition is satisfied. Therefore, the stop condition can be set in accordance with the flow rate of the liquid medium estimated on the basis of the temperature difference between the inlet temperature and the outlet temperature. Accordingly, it becomes possible to properly determine whether or not an abnormal state has occurred on the basis of the result of the determination as to whether the stop condition is satisfied, and the energization of the resistive heating element can be stopped without fail in the case where an abnormal state has occurred. By virtue of this configuration, cracking or melting damage of the ceramic heater can be prevented without fail even when an abnormal state occurs.

In one aspect of the present invention, the ceramic heater (20) is a heat exchanger for heating a liquid medium which flows through a flow passage in an apparatus mounted in a vehicle.

By virtue of the above-described configuration, even when the ceramic heater module is used to heat a liquid medium which flows through a flow passage in an apparatus which is mounted in a vehicle, for example, a refrigerant used in a vehicle air conditioner or a temperature control fluid for controlling the temperature of a vehicle battery, cracking or melting damage of the ceramic heater can be prevented. Thus, the range of use of the ceramic heater module can be expanded.

In one aspect of the present invention, the vehicle is any one of an battery electric vehicle, a hybrid electric vehicle, a plug-in hybrid electric vehicle, and a fuel cell electric vehicle.

By virtue of this configuration, the ceramic heater can be used for heating a drive battery mounted in a vehicle. The ceramic heater has higher temperature elevating performance as compared with PTC heaters, sheath heaters, etc., and is small and light. Therefore, as compared with configurations in which these heaters are used, it is possible to secure a long life of a battery, increase the degree of freedom in laying out the ceramic heater mounted in the vehicle, and reduce power consumption.

A ceramic heater unit (100) according to the present invention includes:
a ceramic heater module (1) which includes a ceramic heater (20) having a ceramic base body including a resistive heating element embedded therein, and a case (10) housing the ceramic heater and having an inlet (11) and an outlet (12) through which a liquid medium flows; and
the ceramic heater module control apparatus (35) according to the present invention.

By virtue of this configuration, it is possible to provide a ceramic heater unit which can prevent, without fail, cracking or melting damage of the ceramic heater even when an abnormal state occurs.

A non-transitory computer readable-recording medium according to the present invention stores a program to be executed by an ECU provided in a ceramic heater module control apparatus for controlling a ceramic heater module (1) which includes a ceramic heater (20) having a ceramic base body including a resistive heating element embedded therein, and a case (10) housing the ceramic heater and having an inlet (11) and an outlet (12) through which a liquid medium flows.

The program is adapted to cause the ECU to execute:
a step of obtaining, as an outlet temperature, a temperature on an outlet side with respect to the ceramic heater module every time a predetermined obtainment time elapses;
a step (S11) of starting supply of a predetermined power to the resistive heating element;
a step (S16, S21, S23) of determining whether or not a predetermined stop condition is satisfied, on the basis of a temperature difference (ΔT1, ΔT2) between a start temperature (Ts) and a detection temperature (T1, T2), the start temperature (Ts) being the outlet temperature at an energization start time point at which supply of the predetermined power to the resistive heating element is started, and the detection temperature (T1, T2) being the outlet temperature obtained at one or a plurality of specific time points after the energization start time point; and
a step (S17, S22) of stopping the energization of the resistive heating element in the case where it is determined that the stop condition is satisfied (S16: Yes, S21: Yes, S23: Yes).

By virtue of this configuration, it is possible to prevent cracking or melting damage of the ceramic heater without fail even when an abnormal state occurs.

Another non-transitory computer readable-recording medium according to the present invention stores a program to be executed by an ECU provided in a ceramic heater module control apparatus for controlling a ceramic heater module (1) which includes a ceramic heater (20) having a ceramic base body including a resistive heating element embedded therein, and a case (10) housing the ceramic heater and having an inlet (11) and an outlet (12) through which a liquid medium flows.

The program is adapted to cause the ECU to execute:
a step of obtaining, as an inlet temperature (T3 in, T4 in), a temperature on an inlet side with respect to the ceramic heater module and obtaining, as an outlet temperature (T3, T4), a temperature on an outlet side with respect to the ceramic heater module every time a predetermined obtainment time elapses;
a step of starting supply of a predetermined power to the resistive heating element;
a step of determining whether or not a predetermined stop condition is satisfied, on the basis of a temperature difference (ΔT3, ΔT4) between the inlet temperature and the outlet temperature at one or a plurality of specific time points after an energization start time point (t=0) at which supply of the predetermined power to the resistive heating element is started; and
a step of stopping the energization of the resistive heating element in the case where it is determined that the stop condition is satisfied.

By virtue of this configuration, it is possible to prevent cracking or melting damage of the ceramic heater without fail even when an abnormal state occurs.

### BRIEF DESCRIPTION OF THE DRAWINGS

FIG. 1 is a schematic partial sectional view of a heating apparatus which includes a ceramic heater and a control unit including a control apparatus according to an embodiment;

FIG. 2A is a graph showing, for each of different flow rates of liquid flowing through a case, change in outlet temperature increase amount with time in the case where the control apparatus controls the energization state of a resistive heating element on the basis of a stop condition;

FIG. 2B is a graph showing, for each of different flow rates of liquid flowing through the case, change in power with time in the case where the control apparatus controls the energization state of the resistive heating element on the basis of the stop condition;

FIG. 3 is a flowchart showing one example of a program executed by an ECU to cause a control apparatus to execute cracking-melting damage prevention control;

FIG. 4A is a graph showing, for each of different flow rates of liquid flowing through the case, change with time in the temperature difference between inlet temperature and outlet temperature in the case where a control apparatus according to a modification controls the energization state of the resistive heating element on the basis of the stop condition; and

FIG. 4B is a graph showing, for each of different flow rates of liquid flowing through the case, change in power with time in the case where the control apparatus controls the energization state of the resistive heating element on the basis of the stop condition.

### DESCRIPTION OF THE PREFERRED EMBODIMENT

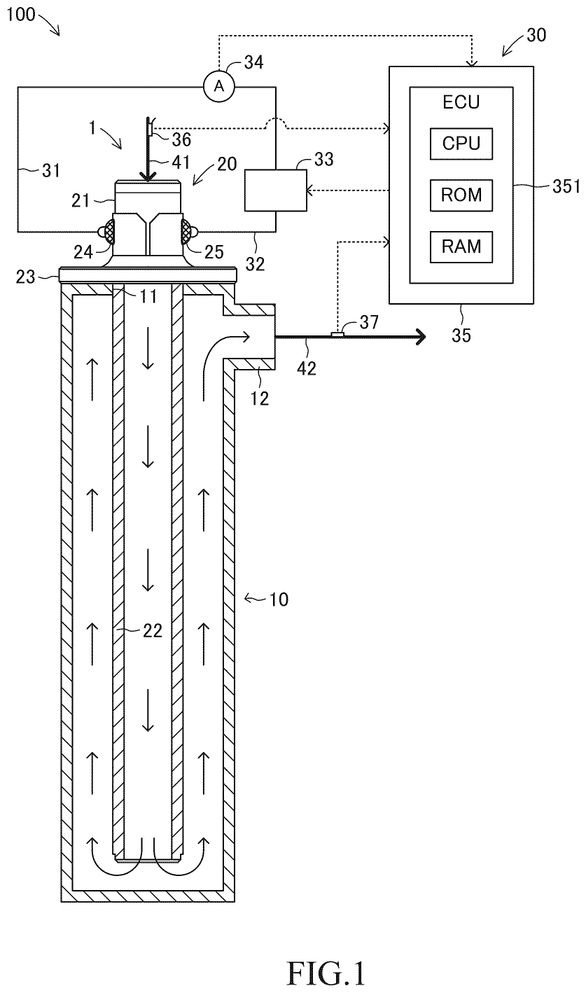

An embodiment of the present invention will now be described with reference to the drawings. FIG. 1 is a schematic configurational view of a heating apparatus 100 which includes a control apparatus 35 according to the present embodiment. As shown in FIG. 1, the heating apparatus 100 includes a ceramic heater module 1 and a control unit 30 including the control apparatus 35. This heating apparatus 100 is a liquid heating apparatus configured to heat a liquid to a predetermined temperature by the ceramic heater module 1. For convenience of explanation, in FIG. 1, the ceramic heater module 1 is shown by its partial cross sectional view. Notably, the heating apparatus 100 corresponds to the “ceramic heater unit.”

The ceramic heater module 1 includes a case 10 and a ceramic heater 20. The case 10 is a member which defines a flow path of the liquid to be heated by the ceramic heater 20. The case 10 has the shape of a cylindrical tube having closed opposite ends. In FIG. 1, the case 10 is shown by a cross section including an axial line. A circular hole 11 is formed in a center portion of an upper end wall of the case 10 such that the circular hole 11 penetrates the upper end wall in an axial direction. A tubular outlet passage portion 12 is provided in a portion of a side circumferential wall of the case 10, the portion being located on the upper side in FIG. 1. Outlet piping 42 is connected to the outlet passage portion 12. Therefore, a space inside the case 10 communicates with a space inside the outlet piping 42 through the outlet passage portion 12. The liquid discharged from the case 10 flows through the outlet piping 42. The circular hole 11 corresponds to the “inlet” of the case 10, and the outlet passage portion 12 corresponds to the “outlet” of the case 10.

The ceramic heater 20 includes a resistive heating element and a ceramic base body. The resistive heating element is a member which generates heat upon energization and is formed by a long conducting wire such that it has a predetermined pattern. An example of the resistive heating element is a tungsten wire. The resistive heating element is embedded in the ceramic base body. The ceramic base body is a member for heating an object to be heated and is heated by the resistive heating element embedded therein. The ceramic base body is formed of a ceramic material. The ceramic base body is formed of, for example, alumina.

The ceramic heater 20 generally has the shape of a cylindrical tube whose opposite ends are open. The cylindrical tubular ceramic heater 20 can be manufactured, for example, as follows. A resistive heating element formed into a predetermined pattern is sandwiched by two ceramic green sheets so as to form a laminate, and the laminate is wound around a circular tubular ceramic body. Subsequently, the ceramic body with the laminate wound therearound is fired. Thus, the circular tubular ceramic heater 20 having the ceramic base body and the resistive heating element embedded therein can be manufactured. The ceramic heater 20 has a base portion 21, a main body portion 22, and a flange portion 23. The base portion 21 and the main body portion 22 are juxtaposed to each other along the axial direction. The base portion 21 is formed by one end portion (an end portion on the upper side in FIG. 1) of the ceramic heater 20 having a generally circular tubular shape. Inlet piping 41 is connected to an end (an upper end in FIG. 1) of the base portion 21. The liquid to be heated by the ceramic heater 20 is introduced from the inlet piping 41 toward the internal space of the base portion 21.

The main body portion 22 is formed by a circular tubular portion other than the base portion 21. As shown in FIG. 1, the length of the main body portion 22 in the axial direction is greater than that of the base portion 21 in the axial direction. The base portion 21 and the main body portion 22 are formed coaxially in a circular tubular shape. The spaces inside the base portion 21 and the main body portion 22 communicate with each other in the axial direction. A ring-shaped flange portion 23 is attached to the outer circumference at the position of the boundary between the base portion 21 and the main body portion 22 such that the flange portion 23 extends radially outward. A first electrode 24 and a second electrode 25 are provided on the outer circumferential surface of the base portion 21. Both the first electrode 24 and the second electrode 25 are formed of an electrically conductive material such as metal.

The length of the main body portion 22 in the axial direction is smaller than that of the case 10. The outer diameter of the main body portion 22 is approximately equal to the diameter of the circular hole 11 formed at the center of the upper end wall of the case 10. The main body portion 22 is inserted, from its distal end portion, into the internal space of the case 10 through the circular hole 11. As a result, the main body portion 22 is disposed in the internal space of the case 10 coaxially with the case 10. At that time, the base portion 21 is exposed upward from the upper end of the case 10, and the flange portion 23 is placed on the upper end surface of the case 10. Notably, the gap between the outer circumference of the upper end of the main body portion 22 and the wall surface of the circular hole 11 is liquid-tightly sealed by a seal member or the like.

The resistive heating element of the ceramic heater 20 is embedded mainly in the ceramic base body constituting the main body portion 22 in such a manner that the resistive heating element forms a predetermined pattern. Opposite end portions of the resistive heating element are extended to the base portion 21 and are connected to the first electrode 24 and the second electrode 25 provided on the surface of the base portion 21. Accordingly, when a predetermined voltage is applied between the first electrode 24 and the second electrode 25, power is supplied to the resistive heating element; i.e., the resistive heating element is energized (current flows through the resistive heating element).

The control unit 30 includes a first electricity conducting member 31, a second electricity conducting member 32, a power supply apparatus 33, an ammeter 34, the control apparatus 35, an inlet temperature sensor 36, and an outlet temperature sensor 37.

Each of the first electricity conducting member 31 and the second electricity conducting member 32 is composed of a conductor having one end (first end) and the other end (second end). The first electricity conducting member 31 and the second electricity conducting member 32 are, for example, lead wires. The first end of the first electricity conducting member 31 is connected to the first electrode 24, and the first end of the second electricity conducting member 32 is connected to the second electrode 25. The second end of the first electricity conducting member 31 and the second end of the second electricity conducting member 32 are connected to the power supply apparatus 33. The power supply apparatus 33 is configured to be capable of applying the predetermined voltage between the first electricity conducting member 31 (the first electrode 24) and the second electricity conducting member 32 (the second electrode 25). The ammeter 34 is provided in the middle of the first electricity conducting member 31. The ammeter 34 measures the current flowing through the first electricity conducting member 31. The ammeter 34 may be provided in the second electricity conducting member 32.

The inlet temperature sensor 36 is attached to the inlet piping 41 and can detect the temperature of the liquid flowing through the inlet piping 41. As described above, the inlet piping 41 is connected to the end of the base portion 21. Therefore, it can be said that the inlet temperature sensor 36 detects the “temperature on the inlet side with respect to the ceramic heater module 1.” In the following description, the “temperature on the inlet side with respect to the ceramic heater module 1” will be referred to also as the “inlet temperature.” Notably, the “inlet temperature” can be said as the “temperature on the liquid introduction side with respect to the ceramic heater module 1.”

The outlet temperature sensor 37 is attached to the outlet piping 42 and can detect the temperature of the liquid flowing through the outlet piping 42. As described above, the outlet piping 42 communicates with the outlet passage portion 12. Therefore, it can be said that the outlet temperature sensor 37 detects the “temperature on the outlet side with respect to the ceramic heater module 1.” In the following description, the “temperature on the outlet side with respect to the ceramic heater module 1” will be referred to also as the “outlet temperature.” Notably, the “outlet temperature” can be said as the “temperature on the liquid discharge side with respect to the ceramic heater module 1.”

The control apparatus 35 controls the ceramic heater 20. Specifically, the control apparatus 35 controls the state of energization of the resistive heating element of the ceramic heater 20 (start/stoppage of energization, power) such that the temperature of the liquid heated by the ceramic heater 20 becomes equal to a predetermined target temperature. The control apparatus 35 has an ECU 351 which includes a CPU, a ROM, and a RAM. Notably, the ECU is an abbreviation for electronic control unit.

A program for controlling the state of energization of the resistive heating element is previously stored in the ROM of the ECU 351. The CPU of the ECU 351 reads the program from the ROM, loads it into the RAM, and executes it.

The ammeter 34 sends a current signal representing the measured current value to the control apparatus 35. The ECU 351 of the control apparatus 35 obtains the current flowing through the first electricity conducting member 31 on the basis of the current signal received from the ammeter 34. The inlet temperature sensor 36 detects the inlet temperature (typically, the temperature of the liquid flowing through the inlet piping 41) and sends a temperature signal representing the detected temperature to the control apparatus 35. The ECU 351 of the control apparatus 35 obtains the inlet temperature on the basis of the temperature signal received from the inlet temperature sensor 36. The outlet temperature sensor 37 detects the outlet temperature (typically, the temperature of the liquid flowing through the outlet piping 42) and sends a temperature signal representing the detected temperature to the control apparatus 35. The ECU 351 of the control apparatus 35 obtains the outlet temperature on the basis of the temperature signal received from the outlet temperature sensor 37. The control apparatus 35 may receive signals other than the above-described signals. The control apparatus 35 is configured to be capable of controlling the power supply apparatus 33 on the basis of various types of signals (current signal, temperature signals, etc.) inputted thereto. As a result of the control of the power supply apparatus 33 by the control apparatus 35, the state of energization of the resistive heating element of the ceramic heater 20 is controlled. Notably, the power supply apparatus 33 may be incorporated into the control apparatus 35.

In the present embodiment, the heating apparatus 100 having the above-described configuration heats a liquid medium flowing through a flow passage in an apparatus mounted in a vehicle. At that time, the ceramic heater 20 functions as a heat exchanger for heating the liquid medium flowing through the flow passage in the apparatus mounted in the vehicle. Examples of the apparatus mounted in the vehicle include a vehicle air conditioner, a temperature control apparatus for a vehicle battery, etc. Examples of the flow passage in the apparatus mounted in the vehicle include a flow passage in a refrigerant circuit of the vehicle air conditioner, a flow passage formed in the temperature control apparatus for the vehicle battery, etc. In this case, the ceramic heater 20 functions as a heat exchanger for heating a refrigerant flowing through the refrigerant circuit of the vehicle air conditioner, or functions as a heat exchanger for heating a temperature controlling fluid flowing through the flow passage formed in the temperature control apparatus for the vehicle battery. Notably, the vehicle may be an battery electric vehicle, a hybrid electric vehicle, a plug-in hybrid electric vehicle, or a fuel cell electric vehicle.

In the heating apparatus 100 having the above-described configuration, the liquid, which is an object to be heated, is introduced from the inlet piping 41 into the space inside the base portion 21 of the ceramic heater 20 and is then introduced from the base portion 21 into the internal space of the main body portion 22.

The liquid introduced into the internal space of the main body portion 22 flows downward in the main body portion 22 as indicated by arrows in FIG. 1, and flows out from the main body portion 22 through an opening at the distal end (lower end) of the main body portion 22. The liquid having flowed out from the main body portion 22 flows upward in the space between the inner wall surface of the side circumferential wall of the case 10 and the outer wall surface of the main body portion 22 as indicated by arrows in FIG. 1, and is discharged to the outlet piping 42 through the outlet passage portion 12 provided at an upper portion of the case 10. In this manner, the case 10 defines a liquid flow passage through which the liquid introduced (supplied) from the inlet piping 41 flows before being discharged to the outlet piping 42.

When the liquid is flowing into the case 10, the control apparatus 35 controls the power supply apparatus 33 such that a predetermined voltage is applied between the first electricity conducting member 31 (the first electrode 24) and the second electricity conducting member 32 (the second electrode 25). As a result, power is supplied to the resistive heating element; i.e., the resistive heating element is energized. The resistive heating element generates heat when energized. The main body portion 22 is heated as a result of heat generation of the resistive heating element. Therefore, the liquid flowing along the surfaces (inner and outer wall surfaces) of the heated main body portion 22 is heated by the main body portion 22. In this manner, the liquid is heated by the heating apparatus 100 (the ceramic heater 20), and the heated liquid is discharged to the outlet piping 42.

The control apparatus 35 obtains, as an inlet temperature, the temperature of the liquid before being heated by the heating apparatus 100, on the basis of the temperature signal sent from the inlet temperature sensor 36 attached to the inlet piping 41. In addition, the control apparatus 35 obtains, as an outlet temperature, the temperature of the liquid after being heated by the heating apparatus 100, on the basis of the temperature signal sent from the outlet temperature sensor 37 attached to the outlet piping 42. The control apparatus 35 controls the power supply apparatus 33 such that the outlet temperature becomes equal to a target temperature. Thus, the temperature of the liquid can be controlled such that the temperature of the liquid discharged to the outlet piping 42 becomes equal to a predetermined target temperature. In this case, the control apparatus 35 can control the temperature of the liquid such that the outlet temperature approaches the target temperature by means of Pl control based on the difference between the outlet temperature and the target temperature.

In the case where the heating apparatus 100 is operating normally, the liquid introduced into the heating apparatus 100 comes into contact with the entire surfaces (inner and outer wall surfaces) of the main body portion 22 of the ceramic heater 20. Accordingly, the main body portion 22 is heated by the resistive heating element and is cooled by the liquid flowing along the surfaces. Therefore, the surface temperature of the main body portion 22 increases sharply immediately after the start of energization of the resistive heating element. However, immediately after the sharp increase, the surface temperature asymptotically changes to a temperature at which the heating balances with the cooling, and is soon maintained at a nearly constant temperature. Thus, the liquid is heated by the main body portion 22 whose surface temperature is maintained at the nearly constant temperature.

An unillustrated pump is connected to the heating apparatus 100, and the flow rate of the liquid supplied to the heating apparatus 100 depends on the performance of the pump. If an abnormal state (e.g., the output of the pump decreases for some reason or foreign matter is mixed into the liquid) occurs, the flow rate of the liquid flowing inside the case 10 (namely, the liquid flowing along the surface of the ceramic heater 20 (to be precise, the main body portion 22) at the time when operation of the heating apparatus 100 is started (in other words, when energization of the resistive heating element is started) decreases or the liquid stagnates in some cases. The flow rate in the former case is, for example, 1 to 2 L/min, and the flow rate in the latter case is 0 L/min. In these cases, the amount of heat supplied from the main body portion 22 to the liquid increases, and the liquid may boil. When the liquid boils within the case 10, boiling bubbles are produced within the case 10. In the case where the produced boiling bubbles come into contact with the surface of the main body portion 22, the region of the surface of the main body portion 22, with which the boiling bubbles are in contact, is not in contact with the liquid, so that that region is not cooled by the liquid. Therefore, the temperature of that region increases sharply. When the liquid again comes into contact with that region as a result of, for example, moving of the boiling bubbles, the region is cooled rapidly by the liquid, so that thermal shock acts on the ceramic base body constituting the main body portion 22. The ceramic base body constituting the main body portion 22 is relatively low in resistance to thermal shock. Therefore, if the applied thermal shock is large, cracking may occur in the ceramic heater 20 (the main body portion 22).

Alternatively, the above described abnormal state may cause a state in which the liquid is not introduced to the inlet piping 41 and the liquid is not present in the case 10 (namely, the ceramic heater 20). In this state, when operation of the heating apparatus 100 is started, since the main body portion 22 is heated by the heat generation of the resistive heating element without being cooled by the liquid, the surface temperature increases sharply, resulting in so-called no-water heating, and melting damage of the ceramic heater 20 may occur.

Accordingly, it has been demanded that the control apparatus 35 controls the energization of the resistive heating element in such a manner as to prevent cracking or melting damage of the ceramic heater 20 which would otherwise occur because of occurrence of an abnormal state. In view of this, in the present embodiment, the control apparatus 35 is configured to determine whether or not predetermined stop conditions are satisfied and stop energization of the resistive heating element when the stop conditions are satisfied. This will be described specifically below.

The stop conditions include a first stop condition and a second stop condition described below.

The first stop condition is that the temperature difference ΔT1 between a start temperature Ts and a detection temperature T1 is equal to or smaller than a predetermined threshold value T1ₜₕ.

The second stop condition is that the temperature difference ΔT2 between the start temperature Ts and a detection temperature T2 is equal to or larger than a predetermined threshold value T2ₜₕ.

The start temperature Ts is the outlet temperature at a point in time when energization of the resistive heating element is started (hereinafter referred to also as the “energization start time point”). The detection temperature T1 is the outlet temperature at a point in time (hereinafter referred to also as the “first reference time point”) after elapse of a predetermined time period t1 from the energization start time point. The detection temperature T2 is the outlet temperature at each of a plurality of points in time which successively come, every time a predetermined short time tm elapses, after the energization start time point. In other words, the detection temperature T2 is the outlet temperature periodically obtained at time intervals of the short time tm after the energization start time point. The determination as to whether or not the second stop condition is satisfied is made, at the latest, until a point in time (hereinafter referred to also as the “second reference time point”) that has elapsed a predetermined time period t2 from the energization start time point. Namely, whereas the determination as to whether or not the first stop condition is satisfied is made only one time at the first reference time point, the determination as to whether or not the second stop condition is satisfied is made a plurality of times; i.e., every time the short time tm elapses, at the latest, until the second reference time point. The time period t2 is longer than the time period t1 (t2>t1), and the threshold value T2ₜₕ is larger than the threshold value T1ₜₕ (T2ₜₕ>T1ₜₕ). In the present embodiment, during a period during which the determinations as to whether these stop conditions are satisfied are made, power of 2 kW is supplied to the resistive heating element (this will be described later). During normal time, the liquid is supplied to the case 10 at a flow rate of 5 L/min. On the basis of this operating environment, the time period t1 is set to 4 seconds, and the time period t2 is set to 10 seconds. The threshold value T1ₜₕ is set to 1.0° C., and the threshold value T2ₜₕ is set to 15.0° C. Although these values may be determined on the basis of the results of an experiment or simulation, different values may be used. Notably, the time periods t1 and t2 correspond to the “first time period” and the “second time period,” respectively, and the threshold values T1ₜₕ and T2ₜₕ correspond to the “first threshold value” and the “second threshold value,” respectively. The “first reference time point” corresponds to the “specific time point.” Also, each of “a plurality of points in time which successively come, every time the short time tm elapses, after the energization start time point” corresponds to the “specific time point.”

At a point in time when the first stop condition or the second stop condition is satisfied, the control apparatus 35 determines that an abnormal state has occurred and stops the energization of the resistive heating element. Meanwhile, the control apparatus 35 supplies preliminary heating power Pl to the resistive heating element until the first stop condition or the second stop condition is satisfied. The preliminary heating power Pl is smaller than normal power Pn supplied to the resistive heating element during normal operation of the ceramic heater 20) (Pl<Pn). Notably, “during normal operation of the ceramic heater 20” means the case where the heating apparatus 100 is operating normally. That is, in the present embodiment, the control apparatus 35 is configured to selectively supply power to the resistive heating element at normal power Pn or at preliminary heating power Pl, which is smaller than normal power Pn. In the present embodiment, the control apparatus 35 supplies power of 2 kW as the preliminary heating power Pl and supplies power of 6 kW as the normal power Pn. However, the powers Pl and Pn are not limited to these values. In the case where the second stop condition is not satisfied until the second reference time point, at second reference time point, the control apparatus 35 changes the power supplied to the resistive heating element from the preliminary heating power Pl to the normal power Pn.

The first stop condition is satisfied when the temperature difference ΔT1(=|the start temperature Ts−the detection temperature T1|) at the first reference time point is equal to or smaller than the threshold value T1ₜₕ. When energization of the resistive heating element is started in a state in which the liquid flowing inside the case 10 stagnates (namely, the flow rate is 0 L/min), the temperature of the liquid near the ceramic base body (in particular, the main body portion 22) increases, and natural convection of the liquid occurs, whereby heat is transferred. Therefore, the outlet temperature tends to increase more slowly as compared with the outlet temperature during normal time. In addition, when energization of the resistive heating element is started in a state in which the liquid is not present in the case 10, the temperature of the air near the ceramic base body (in particular, the main body portion 22) increases, and natural convection of the air occurs, whereby heat is transferred. Therefore, the outlet temperature tends to increase more slowly as compared with the outlet temperature during normal time. Notably, in this case, since the liquid is not present in the outlet piping 42 as well, the outlet temperature sensor 37 detects, as the outlet temperature, the temperature of the air inside the outlet piping 42.

In the case where the liquid stagnates or is not present, the temperature difference ΔT1 tends to become smaller as compared with the temperature difference ΔT1 during normal time. Accordingly, the threshold value T1ₜₕ is set to be equal to or larger than the temperature difference ΔT1 at the case where the liquid stagnates or is not present and be smaller than the temperature difference ΔT1 during normal time. In the present embodiment, during normal time, the liquid is supplied to the case 10 at a flow rate of about 5 L/min, and, as described above, power of 2 kW is supplied as the preliminary heating power Pl. On the basis of this operating environment, the time period t1 is set to 4 seconds, and the threshold value T1ₜₕ is set to 1.0° C. As a result of setting the time period t1 and the threshold value T1ₜₕ as described above, the first stop condition is satisfied only when the liquid stagnates or is not present. Notably, although the time period t1 and the threshold value T1ₜₕ may be determined on the basis of the results of an experiment or simulation, different values may be used. In addition, when the operating environment is changed, the time period t1 and the threshold value T1ₜₕ may be appropriately changed. The time period t1 and the threshold value T1ₜₕ correspond to the “first time period” and the “first threshold value,” respectively.

The second stop condition is satisfied when the temperature difference ΔT2 (=|the start temperature Ts−the detection temperature T2|) detected at a plurality of points in time which successively come, every time the short time tm elapses, after the energization start time point becomes equal to or larger than the threshold value T2ₜₕ. Namely, when energization of the resistive heating element is started in a state in which the flow rate of the liquid flowing inside the case 10 is small (namely, the flow rate is 1 to 2 L/min), the outlet temperature tends to increase more sharply as compared with the outlet temperature during normal time, because, when the flow rate of the liquid is small (namely, the flow speed is low), the time over which the liquid is in contact with the surface of the ceramic heater 20 becomes longer, and the temperature of the liquid increases more quickly as compared with the temperature increase during normal time. Namely, in the case where the flow rate of the liquid is small, the temperature difference ΔT2 tends to become larger as compared with the temperature difference ΔT2 during normal time. Accordingly, the threshold value T2ₜₕ is set to be equal to or smaller than the temperature difference ΔT2 in the case where the flow rate of the liquid is small and be larger than the temperature difference ΔT2 during normal time. In addition, even when the flow rate of the liquid is in a normal range, the outlet temperature increases with the energization time. Therefore, the time period T2 (the longest period during which the determination is made as to whether or not the second stop condition is satisfied) is set such that, during the time period T2, the amount of increase (from the energization start time point) in the outlet temperature of the liquid flowing at a flow rate within the normal range does not exceed the threshold value T2ₜₕ. On the basis of the above-described operating environment, the time period t2 is set to 10 seconds, and the threshold value T2ₜₕ is set to 15.0° C. As a result of setting the time period t2 and the threshold value T2ₜₕ as described above, the second stop condition is satisfied only when the flow rate of the liquid is small. Notably, although the time period t2 and the threshold value T2ₜₕ may be determined on the basis of the results of an experiment or simulation, different values may be used. In addition, when the operating environment is changed, the time period t2 and the threshold value T2ₜₕ may be appropriately changed. The time period t2 and the threshold value T2ₜₕ correspond to the “second time period” and the “second threshold value,” respectively.

When energization of the resistive heating element is started, the control apparatus 35 starts the determination as to whether or not the second stop condition is satisfied. In the case where the control apparatus 35 determines that the second stop condition is not satisfied, the control apparatus 35 determines that an abnormal state has not occurred, and maintains the power supplied to the resistive heating element at the preliminary heating power Pl. In the case where the first reference time point comes during performance of the determination as to whether or not the second stop condition is satisfied, the control apparatus 35 performs the determination for the first stop condition. In the case where the control apparatus 35 determines that the first stop condition is not satisfied, the control apparatus 35 determines that an abnormal state has not occurred, and continuously maintains the preliminary heating power Pl. After the first reference time point, the control apparatus 35 continues the determination for the second stop condition, and, in the case where the control apparatus 35 determines that the second stop condition is not satisfied, the control apparatus 35 continuously maintains the preliminary heating power Pl. In the case where the control apparatus 35 determines at the second reference time point that the second stop condition is not satisfied, the control apparatus 35 determines that an abnormal state has not occurred and changes the power supplied to the resistive heating element from the preliminary heating power Pl to the normal power Pn.

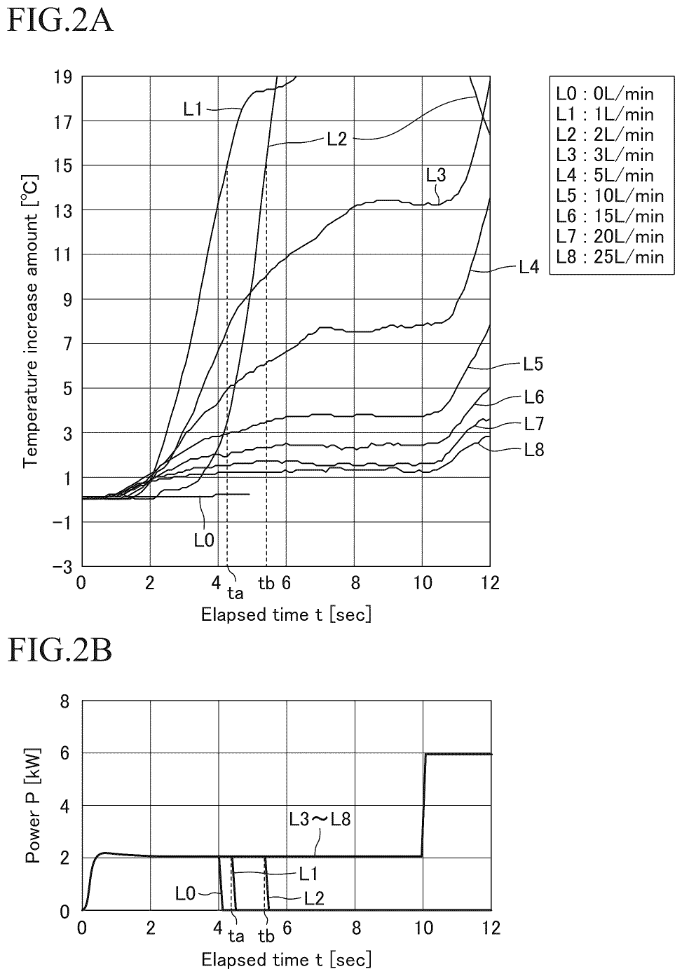

FIGS. 2A and 2B are graphs which respectively show the amount of outlet temperature increase and power P in the case where the control apparatus 35 controls the energization state of the resistive heating element on the basis of the first and second stop conditions. The horizontal axis of the graph of FIG. 2A represents the time t (sec) elapses after the energization start time point and the vertical axis of the graph shows the amount of outlet temperature increase (° C.) from the energization start time point (in other words, the temperature increase (difference) from the start temperature Ts). As in FIG. 2A, the horizontal axis of the graph of FIG. 2B represents the time t (sec), and the vertical axis of the graph represents the power P (kW) supplied to the resistive heating element. In these graphs, changes in the amount of outlet temperature increase and the power P are shown for nine cases in which the flow rate of the liquid was set to nine different values, from 0 L/min to 25 L/min.

The control apparatus 35 supplies the preliminary heating power Pl of 2 kW to the resistive heating element at the time point of t=0 (see FIG. 2B). As a result, as shown in FIG. 2A, in the case where the flow rate is equal to or larger than 1 L/min, the outlet temperature increases with time (see lines L1 to L8). In particular, in the case where the flow rate is 1 L/min or 2 L/min (namely, the flow rate is small), the rate of increase in the outlet temperature is larger as compared with the case where the flow rate is 3 L/min or larger (see lines L1 and L2). Meanwhile, in the case where the flow rate is 0 L/min (namely, the liquid stagnates), the rate of increases in the outlet temperature is very small (see line L0).

The control apparatus 35 determines whether or not the second stop condition (ΔT2≥15.0° C.) is satisfied, every time the short time tm elapses from the time point of t=0 (in other words, at a plurality of points in time which successively come every time the short time tm elapses). The temperature increase amounts (the values along the vertical axis), represented by each of the lines L0 to L8, at the above-described plurality of points in time are equal to the temperature difference ΔT2 between the start temperature Ts and the detection temperature T2. This determination is made, at the latest, until the time point of t=10. In addition, at the time point of t=4, the control apparatus 35 determines whether or not the first stop condition (ΔT1≤1.0° C.) is satisfied. The temperature increase amount (the value along the vertical axis), represented by each of the lines L0 to L8, at the time point of t=4 is equal to the temperature difference ΔT1 between the start temperature Ts and the detection temperature T1. In this example, ΔT1≤1.0° C. only in the case where the flow rate is 0 L/min, and ΔT1>1.0° C. in the case where the flow rate is 1 L/min or larger. Therefore, only in the case where the flow rate is 0 L/min, the control apparatus 35 determines that the first stop condition is satisfied, and stops the energization of the resistive heating element at the time point of t=4. In the case where the flow rate is 1 L/min or larger, the control apparatus 35 maintains the preliminary heating power Pl (2 kW) even in the period where t≥4 (see FIG. 2B). Notably, in the case where the flow rate is 0 L/min, measurement of the temperature increase amount is ended at the time point of t=5.

In the period where t>4, the second stop condition (ΔT2≥15.0° C.) is satisfied in some cases. Specifically, in the case where the flow rate is 1 L/min, ΔT2 becomes 15.0° C. or larger at the time point of t=ta, and, in the case where the flow rate is 2 L/min, ΔT2 becomes 15.0° C. or larger at the time point of t=tb (>ta). Meanwhile, in the case where the flow rate is 3 L/min or larger, ΔT2 is smaller than 15.0° C. up to the time point of t=10. Therefore, in the case where the flow rate is 1 L/min, the control apparatus 35 determines that the second stop condition is satisfied at the time point of t=ta, and stops the energization of the resistive heating element at that time point (see FIG. 2B). As a result, as shown in FIG. 2A, in the case where the flow rate is 1 L/min, the rate of increase in the outlet temperature becomes small, with some time lag, after stoppage of the energization (see line L1). Although not shown in the graph, the outlet temperature is then presumed to start decreasing. In the case where the flow rate is 2 L/min, the control apparatus 35 determines that the second stop condition is satisfied at the time point of t=tb, and stops the energization of the resistive heating element at that time point (see FIG. 2B). It is understood from FIG. 2A that, in the case where the flow rate is 2 L/min, the outlet temperature starts decreasing at a certain point in time at which t>tb is satisfied (see line L2). Meanwhile, in the case where the flow rate is 3 L/min or larger, the control apparatus 35 maintains the preliminary heating power Pl (2 kW) during the period where t<10 and changes the supplied power to the normal power Pn (6 kW) at the time point of t=10 (see FIG. 2B). As a result, as shown in FIG. 2A, in the case where the flow rate is 3 L/min or larger, the outlet temperature increases at a higher rate than before, with some time lag, after the power has been changed (see lines L3 to L8).

In addition, although not shown in the drawings, even in the case where the liquid was not present in the case 10, the preliminary heating power Pl was supplied, and the amount of increase in the outlet temperature was measured. As a result, the temperature increase rate was relatively small, so that the first stop condition was satisfied at the time point of t=4.

The above-described test shows that, in the case where the liquid stagnates inside the case 10 or the liquid is not present in the case 10, energization of the resistive heating element is stopped as a result of satisfaction of the first stop condition, and, in the case where the flow rate of the liquid flowing through the case 10 is small, energization of the resistive heating element is stopped as a result of satisfaction of the second stop condition.

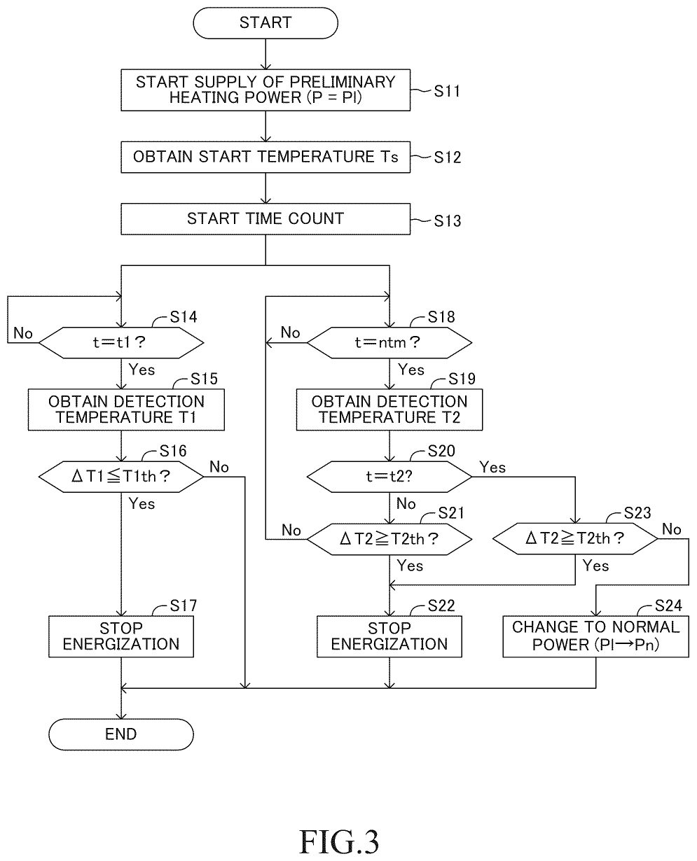

FIG. 3 is a flowchart showing one example of a program executed by the ECU 351 of the control apparatus 35 to cause the control apparatus 35 to execute cracking-melting damage prevention control.

When execution of the program shown in FIG. 3 is started, the ECU 351 first starts supply of a preliminary heating power Pl (=2 kW) to the resistive heating element in step (hereinafter abbreviated as S) 11 of FIG. 3. Notably, when energization of the resistive heating element is started, the ECU 351 executes temperature control (for example, Pl control) for the liquid heated by the heating apparatus 100. Description of a program for executing this temperature control is omitted.

Subsequently, the ECU 351 obtains, as the start temperature Ts, the outlet temperature at the energization start time point from the outlet temperature sensor 37 (S12). Next, the ECU 351 starts counting operation using a timer (S13). Subsequently, the ECU 351 performs in parallel a process from S14 to S17 and a process from S18 to S24. These processes will be successively described below. In S14, the ECU 351 determines whether or not the elapsed time t counted by the timer becomes equal to the time period t1 (=4 sec). In the case where t<t1 (S14: No), the process returns to S14. In the case where t=t1 is satisfied (S14: Yes), the process proceeds to S15.

In S15, the ECU 351 obtains, as the detection temperature T1, the outlet temperature at the time point of t=t1 from the outlet temperature sensor 37. Next, the ECU 351 determines whether or not the temperature difference ΔT1 between the start temperature Ts and the detection temperature T1 is equal to or smaller than the threshold value T1ₜₕ (=1.0° C.) (namely, whether or not the first stop condition is satisfied) (S16). In the case where ΔT1≤T1ₜₕ (S16: Yes), the process proceeds to S17. In S17, the ECU 351 determines that an abnormal state (the liquid has stagnated or is not present) has occurred and stops the energization of the resistive heating element. As a result, boiling of the liquid or non-water heating of the ceramic heater 20 is prevented, whereby cracking or melting damage of the ceramic heater can be prevented without fail. Meanwhile, in the case where ΔT1>T1ₜₕ (S16: No), the ECU 351 ends the execution of the process of S14 to S17. At that time, the ECU 351 maintains the power supplied to the resistive heating element at the preliminary heating power Pl.

In contrast, in S18, the ECU 351 determines whether or not the elapsed time t counted by the timer satisfies t=ntm (n: an integer equal to or greater than 1) (in other words, whether or not the present point in time is one of a plurality of points in time which successively come, every time the short time tm elapses, from the energization start time point). In the case where the elapsed time t is not equal to ntm (S18: No), the process returns to S18. In the case where t=ntm is satisfied (S18: Yes), the process proceeds to S19. In S19, the ECU 351 obtains, as the detection temperature T2, the outlet temperature at the time point of t=ntm from the outlet temperature sensor 37. Subsequently, the ECU 351 determines whether or not the elapsed time t counted by the timer becomes equal to the time period t2 (=10 sec) (S20). In the case where t<t2 (S20: No), the ECU 351 determines whether or not the temperature difference ΔT2 between the start temperature Ts and the detection temperature T2 is equal to or larger than the threshold value T2ₜₕ (=15.0° C.) (namely, whether or not the second stop condition is satisfied) (S21). In the case where ΔT2<T2ₜₕ (S21: No), the process returns to S18. In the case where ΔT2≥T2ₜₕ is satisfied in the process of S18 to S21 (S21: Yes), the process proceeds to S22.

In S22, the ECU 351 determines that an abnormal state (the flow rate of the liquid is insufficient) has occurred and stops the energization of the resistive heating element. As a result, boiling of the liquid is prevented, whereby cracking of the ceramic heater can be prevented without fail. Subsequently, the ECU 351 ends the execution of the process of S18 to S24. Meanwhile, in the case where the condition t=t2 is satisfied in the process of S18 to S21 (S20: Yes), the process proceeds to S23. In S23, the ECU 351 determines whether or not ΔT2≥T2ₜₕ (namely, whether or not the second stop condition is satisfied). In the case where ΔT2≥T2ₜₕ (S23: Yes), in S22, the ECU 351 stops the energization of the resistive heating element as described above. In contrast, in the case where ΔT2<T2ₜₕ (S23: No), the process proceeds to S24. In S24, the ECU 351 changes the power supplied to the resistive heating element from the preliminary heating power Pl to the normal power Pn (=6 kW). Subsequently, the ECU 351 ends the execution of the process of S18 to S24. The value of the timer is initialized when the process of S22 ends. Notably, in the case where the energization of the resistive heating element is stopped by the process of S17 or S22, execution of the temperature control for the liquid heated by the heating apparatus 100 is also stopped.

As descried above, the control apparatus 35 according to the present embodiment can properly determine whether or not an abnormal state has occurred, on the basis of the results of the determination as to whether or not the first or second stop condition is satisfied, and, in the case where an abnormal state has occurred, the control apparatus 35 can stop the energization of the resistive heating element without fail. Therefore, even when an abnormal state occurs, cracking or melting damage of the ceramic heater 20 can be prevented without fail.

In particular, in the present embodiment, during the period of the determination as to whether or not the first and second stop conditions are satisfied, the preliminary heating power Pl, which is smaller than the normal power Pn, is supplied to the resistive heating element. Therefore, elevation of the surface temperature of the ceramic heater 20 can be suppressed, and, even when an abnormal state occurs, boiling of the liquid and no-water heating of the ceramic heater 20 become less likely to occur. As a result, it is possible to prevent cracking or melting damage of the ceramic heater 20, which would otherwise occur in the middle of the determination as to whether or not the first and second stop conditions are satisfied.

Although an embodiment of the present invention has been described above, the present invention is not limited to the above described embodiment and various modifications may be possible so long as the modifications do not depart from the scope of the invention.

For example, in the embodiment, when the operation of the heating apparatus 100 is started, the preliminary heating power Pl is supplied to the resistive heating element. However, the present invention is not limited to such a configuration. The control apparatus 35 may supply the normal power Pn to the resistive heating element from the point in time when the operation of the heating apparatus 100 is started. In this case, the values of the time periods t1 and t2, the threshold values T1ₜₕ and T2ₜₕ, etc. may be adjusted such that cracking or melting damage of the ceramic heater 20 due to an abnormal state does not occur in the period of the determination as to whether or not the first and second stop conditions are satisfied.

In addition, the control apparatus 35 may be configured to perform only one of the determination for the first stop condition and the determination for the second stop condition.

In a modification, the determination as to whether or not the stop conditions are satisfied may be performed on the basis of the temperature difference between the inlet temperature and the outlet temperature at one or a plurality of specific time points after the energization start time point. In this case, for example, instead of the first and second stop conditions, third and fourth stop conditions may be provided, respectively.

The third stop condition is satisfied in the case where the temperature difference ΔT3 between an inlet temperature T3in and an outlet temperature T3 is equal to or smaller than a predetermined threshold value T3ₜₕ. The inlet temperature T3in and the outlet temperature T3 are the inlet temperature and the outlet temperature obtained at a point in time (hereinafter referred to also as the “third reference time point”) after elapse of a predetermined time period t3 from the energization start time point. The time period t3 and the threshold value T3ₜₕ may be determined on the basis of the results of an experiment or simulation. These values may be the same as or differ from the time period t1 and threshold value T1ₜₕ, respectively.

The fourth stop condition is satisfied in the case where the temperature difference ΔT4 between an inlet temperature T4in and an outlet temperature T4 is equal to or larger than a predetermined threshold value T4ₜₕ. The inlet temperature T4in and the outlet temperature T4 are the inlet temperature and the outlet temperature obtained at each of a plurality of points in time which successively come, every time a predetermined short time tm2 elapses, after the energization start time point. The short time tm2 may be the same as or differ from the short time tm. The determination as to whether or not the fourth stop condition is satisfied is made, at the latest, until a point in time (hereinafter referred to also as the “fourth reference time point”) after elapse of a predetermined time period t4 from the energization start time point. Namely, whereas the determination for the third stop condition is made only one time at the third reference time point, the determination for the fourth stop condition is made a plurality of times; namely, every time the short time tm2 elapses, at the latest, until the fourth reference time point. The time period t4 is longer than the time period t3 (t4>t3), and the threshold value T4ₜₕ is larger than the threshold value T3ₜₕ (T4ₜₕ>T3ₜₕ). The time period t4 and the threshold value T4ₜₕ may be determined on the basis of the results of an experiment or simulation. These values may be the same as or differ from the time period t2 and the threshold value T2ₜₕ, respectively. In addition, the “third reference time point” corresponds to the “specific time point.” Also, the “plurality of points in time which successively come, every time the short time tm2 elapses, after the energization start time point” correspond to the “specific time point.”

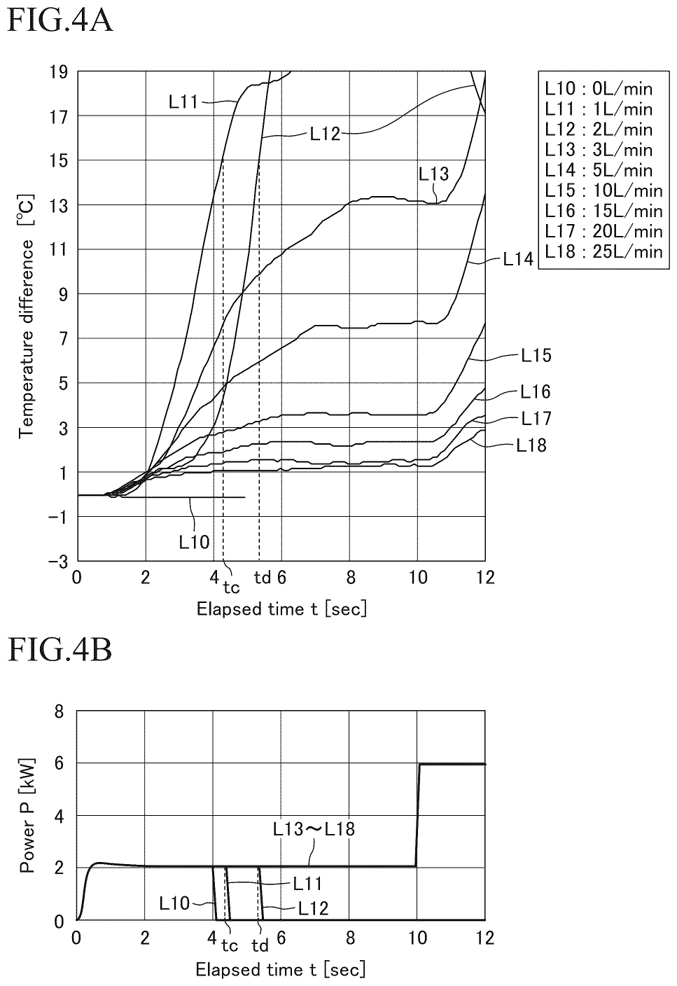

FIGS. 4A and 4B are graphs which respectively show the temperature difference between the inlet temperature and the outlet temperature and power P in the case where the control apparatus 35 controls the energization state of the resistive heating element on the basis of the third and fourth stop conditions. The horizontal axis of the graph of FIG. 4A represents the time t (sec) elapsed from the energization start time point and the vertical axis of the graph shows the temperature difference (° C.) between the inlet temperature and the outlet temperature after the energization start time point. The horizontal axis and the vertical axis of the graph of FIG. 4B are the same as those in FIG. 2B. In this example, t3 is set to be equal to t1 (=4 sec), t4 is set to be equal to t2 (=10 sec), T3ₜₕ is set to be equal to T1ₜₕ (=1.0° C.), and T4n set to be equal to T2ₜₕ (=15.0° C.). As shown in FIGS. 4A and 4B, changes in the temperature difference and the power P represented by lines L10 to L18 are similar to changes in the temperature difference and the power P, represented by lines L0 to L8 of FIGS. 2A and 2B. Specifically, since the third stop condition is satisfied only in the case where the flow rate is 0 L/min (see FIG. 4A), the control apparatus 35 stops the energization of the resistive heating element at the time point of t=4 (see FIG. 4B). In addition, the fourth stop condition is satisfied at the time point of t=tc in the case where the flow rate is 1 L/min and at the time point of t=td (>tc) in the case where the flow rate is 2 L/min (see FIG. 4A). Therefore, the control apparatus 35 stops the energization of the resistive heating element at the time point of t=tc in the former case, and stops the energization of the resistive heating element at the time point of t=td in the latter case (see FIG. 4B). By virtue of this configuration as well, an action and effects similar to those of the embodiment can be attained. Notably, the inlet temperature obtained at the energization start time point may be used as the inlet temperatures T3in and T4 in.

In the present modification, the program represented by the flowchart of FIG. 3 may be modified as follows. After the end of the process of S11, the process proceeds to S13 without performing the process of S12. In S14, the ECU 351 determines whether or not t=t3. In S15, the ECU 351 obtains the inlet temperature T3in and the outlet temperature T3. In S16, the ECU 351 determines whether or not ΔT3≤T3ₜₕ. In S19, the ECU 351 obtains the inlet temperature T4in and the outlet temperature T4. In S20, the ECU 351 determines whether or not t=t4. In each of S21 and S23, the ECU 351 determines whether or not ΔT4≥T4ₜₕ.

Furthermore, the present disclosure encompasses the following modes.

[1]

A ceramic heater module control apparatus for controlling a ceramic heater module which includes a ceramic heater having a ceramic base body including a resistive heating element embedded therein, and a case housing the ceramic heater and having an inlet and an outlet through which a liquid medium flows, wherein
the ceramic heater module control apparatus is configured to:
   obtain, as an outlet temperature, a temperature on an outlet side with respect to the ceramic heater module;
   determine whether or not a predetermined stop condition is satisfied, on the basis of a temperature difference between a start temperature and a detection temperature, the start temperature being the outlet temperature at an energization start time point at which energization of the resistive heating element with a predetermined power is started, and the detection temperature being the outlet temperature obtained at one or a plurality of specific time points after the energization start time point; and
   stop the energization of the resistive heating element in the case where it is determined that the stop condition is satisfied.
      [2]

The ceramic heater module control apparatus described in the above paragraph [1], wherein the predetermined power is power smaller than normal power suppled to the resistive heating element during normal operation of the ceramic heater.

[3]

The ceramic heater module control apparatus described in the above paragraph [1] or [2], wherein
the stop condition includes a first stop condition,
the specific time point is a first reference time point after elapse of a predetermined first time period from the energization start time point, and
the control apparatus determines that the first stop condition is satisfied in the case where the temperature difference is equal to or smaller than a predetermined first threshold value.
   [4]

The ceramic heater module control apparatus described in the above paragraph [3], wherein
the predetermined power is power smaller than normal power supplied during normal operation of the ceramic heater, and
in the case where the control apparatus determines that the first stop condition is not satisfied, the control apparatus maintains the power supplied to the resistive heating element at the predetermined power until a predetermined reference time point after the first reference time point.
   [5]

The ceramic heater module control apparatus described in any one of the above paragraphs [1] to [4], wherein
the stop condition includes a second stop condition,
the specific time point is each of a plurality of points in time which successively come, every time a predetermined short time elapses, after the energization start time point,
the control apparatus determines that the second stop condition is satisfied in the case where the temperature difference is equal to or larger than a predetermined second threshold value, and
in the case where the second stop condition is not satisfied, the control apparatus continues the determination as to whether or not the second stop condition is satisfied, until a second reference time point after elapse of a predetermined second time period from the energization start time point.
   [6]

The ceramic heater module control apparatus described in the above paragraph [5], wherein
the predetermined power is power smaller than normal power supplied during normal operation of the ceramic heater,
in the case where the control apparatus determines that the second stop condition is not satisfied before the second reference time point, the control apparatus maintains the power supplied to the resistive heating element at the predetermined power, and
in the case where the control apparatus determines that the second stop condition is not satisfied at the second reference time point, the control apparatus changes the power supplied to the resistive heating element from the predetermined power to the normal power.
   [7]

A ceramic heater module control apparatus for controlling a ceramic heater module which includes a ceramic heater having a ceramic base body including a resistive heating element embedded therein, and a case housing the ceramic heater and having an inlet and an outlet through which a liquid medium flows, wherein
the ceramic heater module control apparatus is configured to:
obtain, as an inlet temperature, a temperature on an inlet side with respect to the ceramic heater module, and obtain, as an outlet temperature, a temperature on an outlet side with respect to the ceramic heater module;
determine whether or not a predetermined stop condition is satisfied, on the basis of a temperature difference between the inlet temperature and the outlet temperature at one or a plurality of specific time points after an energization start time point at which energization of the resistive heating element with a predetermined power is started; and
stop the energization of the resistive heating element in the case where it is determined that the stop condition is satisfied.
   [8]

The ceramic heater module control apparatus described in any one of the above paragraphs [1] to [7], wherein
the ceramic heater is a heat exchanger for heating a liquid medium which flows through a flow passage in an apparatus mounted in a vehicle.
   [9]

The ceramic heater module control apparatus described in the above paragraph [8], wherein the vehicle is any one of a battery electric vehicle, a hybrid electric vehicle, a plug-in hybrid electric vehicle, and a fuel cell electric vehicle.

[10]

A ceramic heater unit comprising:
a ceramic heater module which includes a ceramic heater having a ceramic base body including a resistive heating element embedded therein, and a case housing the ceramic heater and having an inlet and an outlet through which a liquid medium flows; and
a ceramic heater module control apparatus described in any one of the paragraphs [1] to [9].
   [11]

A non-transitory computer readable-recording medium which stores a program to be executed by an ECU provided in a ceramic heater module control apparatus for controlling a ceramic heater module which includes a ceramic heater having a ceramic base body including a resistive heating element embedded therein, and a case housing the ceramic heater and having an inlet and an outlet through which a liquid medium flows,
the program being adapted to cause the ECU to execute:
a step of obtaining, as an outlet temperature, a temperature on an outlet side with respect to the ceramic heater module every time a predetermined obtainment time elapses;
a step of starting supply of a predetermined power to the resistive heating element;
a step of determining whether or not a predetermined stop condition is satisfied, on the basis of a temperature difference between a start temperature and a detection temperature, the start temperature being the outlet temperature at an energization start time point at which supply of the predetermined power to the resistive heating element is started, and the detection temperature being the outlet temperature obtained at one or a plurality of specific time points after the energization start time point; and
a step of stopping the energization of the resistive heating element in the case where it is determined that the stop condition is satisfied.
   [12]

A non-transitory computer readable-recording medium which stores a program to be executed by an ECU provided in a ceramic heater module control apparatus for controlling a ceramic heater module which includes a ceramic heater having a ceramic base body including a resistive heating element embedded therein, and a case housing the ceramic heater and having an inlet and an outlet through which a liquid medium flows,
the program being adapted to cause the ECU to execute:
a step of obtaining, as an inlet temperature, a temperature on an inlet side with respect to the ceramic heater module and obtaining, as an outlet temperature, a temperature on an outlet side with respect to the ceramic heater module every time a predetermined obtainment time elapses;
a step of starting supply of a predetermined power to the resistive heating element;
a step of determining whether or not a predetermined stop condition is satisfied, on the basis of a temperature difference between the inlet temperature and the outlet temperature at one or a plurality of specific time points after an energization start time point at which supply of the predetermined power to the resistive heating element is started; and
a step of stopping the energization of the resistive heating element in the case where it is determined that the stop condition is satisfied.

### DESCRIPTION OF THE REFERENCE NUMERALS

1: ceramic heater module, 10: case, 11: circular hole, 12: outlet passage portion, 20: ceramic heater, 21: base portion, 22: main body portion, 23: flange portion, 24: first electrode, 25: second electrode, 30: control unit, 31: first electricity conducting member, 32: second electricity conducting member, 33: power supply apparatus, 34: ammeter, 35: control apparatus, 351: ECU, 36: inlet temperature sensor, 37: outlet temperature sensor, 41: inlet piping, 42: outlet piping, 100: heating apparatus

What is claimed is:

1. A ceramic heater module control apparatus for controlling a ceramic heater module which includes a ceramic heater having a ceramic base body including a resistive heating element embedded therein, and a case housing the ceramic heater and having an inlet and an outlet through which a liquid medium flows, wherein
the ceramic heater module control apparatus is configured to
obtain, as an outlet temperature, a temperature on an outlet side with respect to the ceramic heater module;
determine whether or not a predetermined stop condition is satisfied, on the basis of a temperature difference between a start temperature and a detection temperature, the start temperature being the outlet temperature at an energization start time point at which energization of the resistive heating element with a predetermined power is started, and the detection temperature being the outlet temperature obtained at one or a plurality of specific time points after the energization start time point; and
stop the energization of the resistive heating element in the case where it is determined that the stop condition is satisfied.

2. The ceramic heater module control apparatus according to claim 1, wherein the predetermined power is power smaller than normal power suppled to the resistive heating element during normal operation of the ceramic heater.

3. The ceramic heater module control apparatus according to claim 1, wherein
the stop condition includes a first stop condition,
the specific time point is a first reference time point after elapse of a predetermined first time period from the energization start time point, and
the control apparatus determines that the first stop condition is satisfied in the case where the temperature difference is equal to or smaller than a predetermined first threshold value.

4. The ceramic heater module control apparatus according to claim 3, wherein
the predetermined power is power smaller than normal power supplied during normal operation of the ceramic heater, and
in the case where the control apparatus determines that the first stop condition is not satisfied, the control apparatus maintains the power supplied to the resistive heating element at the predetermined power until a predetermined reference time point after the first reference time point.

5. The ceramic heater module control apparatus according to claim 1, wherein
the stop condition includes a second stop condition,
the specific time point is each of a plurality of points in time which successively come, every time a predetermined short time elapses, after the energization start time point,
the control apparatus determines that the second stop condition is satisfied in the case where the temperature difference is equal to or larger than a predetermined second threshold value, and
in the case where the second stop condition is not satisfied, the control apparatus continues the determination as to whether or not the second stop condition is satisfied, until a second reference time point after elapse of a predetermined second time period from the energization start time point.

6. The ceramic heater module control apparatus according to claim 5, wherein
the predetermined power is power smaller than normal power supplied during normal operation of the ceramic heater,
in the case where the control apparatus determines that the second stop condition is not satisfied before the second reference time point, the control apparatus maintains the power supplied to the resistive heating element at the predetermined power, and
in the case where the control apparatus determines that the second stop condition is not satisfied at the second reference time point, the control apparatus changes the power supplied to the resistive heating element from the predetermined power to the normal power.

7. A ceramic heater module control apparatus for controlling a ceramic heater module which includes a ceramic heater having a ceramic base body including a resistive heating element embedded therein, and a case housing the ceramic heater and having an inlet and an outlet through which a liquid medium flows, wherein
the ceramic heater module control apparatus is configured to:
obtain as an inlet temperature, a temperature on an inlet side with respect to the ceramic heater module, and obtain, as an outlet temperature, a temperature on an outlet side with respect to the ceramic heater module;
determine whether or not a predetermined stop condition is satisfied, on the basis of a temperature difference between the inlet temperature and the outlet temperature at one or a plurality of specific time points after an energization start time point at which energization of the resistive heating element with a predetermined power is started; and
stop the energization of the resistive heating element in the case where it is determined that the stop condition is satisfied.

8. The ceramic heater module control apparatus according to claim 1, wherein the ceramic heater is a heat exchanger for heating a liquid medium which flows through a flow passage in an apparatus mounted in a vehicle.

9. The ceramic heater module control apparatus according to claim 8, wherein the vehicle is any one of a battery electric vehicle, a hybrid electric vehicle, a plug-in hybrid electric vehicle, and a fuel cell electric vehicle.

10. A ceramic heater unit comprising:
a ceramic heater module which includes a ceramic heater having a ceramic base body including a resistive heating element embedded therein, and a case housing the ceramic heater and having an inlet and an outlet through which a liquid medium flows; and
a ceramic heater module control apparatus according to claim 1.
